(19) United States
(12) Patent Application Publication
(10) Pub. No.: US 2019/0315113 A1
(43) Pub. Date: Oct. 17, 2019

(54) METHODS OF CUTTING GLASS LAMINATES AND GLASS LAMINATES FORMED USING SUCH METHODS

(71) Applicant: Corning Incorporated, Corning, NY (US)

(72) Inventors: Cheol Hee Park, Cheonan-si (KR); Dong Keun Shin, Hwasung-si (KR)

(21) Appl. No.: 16/343,132

(22) PCT Filed: Oct. 19, 2017
(86) PCT No.: PCT/US2017/057403

§ 371 Date: Apr. 18, 2019

(30) Foreign Application Priority Data
Oct. 19, 2016 (KR) 10-2016-0135933

(51) Int. Cl. B32B 43/00

(52) U.S. Cl. CPC B32B 43/003; B32B 38/0004; B32B 2315/08

(57) ABSTRACT

A method includes cutting a glass laminate having a glass sheet laminated to a non glass substrate along a cutting path to form a glass laminate segment. Prior to cutting, a relief channel is formed in the glass laminate and comprises a first segment aligned with a final segment of the cutting path and a second segment extending away from the final segment of the cutting path. Another method includes forming a cutting channel in a glass laminate to define first and second regions of the glass laminate coupled by a web portion with a thickness of at least about 10% of a glass laminate thickness. The cutting channel is expanded to form an expanded cutting channel and a reduced web portion with a thickness of at least about 0.1% of the glass laminate thickness. The reduced web portion is severed to form a glass laminate segment.

This application claims the benefit of priority to Korean Patent Application No. 10-2016-0135933, filed Oct. 19, 2016, the content of which is incorporated herein by reference in its entirety.

### BACKGROUND

### 1. Field

This disclosure relates to glass laminates and, more particularly, methods of cutting glass laminates.

### 2. Technical Background

Glass laminates may be used as components in the fabrication of various appliances, automobile components, architectural structures, and electronic devices. For example, glass laminates may be incorporated as covering materials for various products such as walls, cabinets, backsplashes, appliances, or televisions. However, it may be difficult to cut or otherwise shape glass laminates using conventional machining methods without causing fractures in the glass layer. For example, many such machining methods are not generally used to cut some of the materials or layers found in glass laminates, such as glass, plastic or adhesives.

### SUMMARY

Disclosed herein are methods of cutting glass laminates and glass laminates formed using such methods.

Disclosed herein is a method comprising cutting a glass laminate comprising a glass sheet laminated to a non-glass substrate along a cutting path to form a glass laminate segment comprising a perimeter at least partially defined by the cutting path. Prior to the cutting, a relief channel is formed in the glass laminate. The relief channel comprises a first segment aligned with a final segment of the cutting path and a second segment extending away from the final segment of the cutting path such that, after the cutting, the second segment is disposed outside of the glass laminate segment.

Disclosed herein is a method comprising forming a cutting channel in a glass laminate comprising a glass sheet laminated to a non-glass substrate. The cutting channel defines a first region of the glass laminate and a second region of the glass laminate coupled to each other by a web portion disposed between the cutting channel and a surface of the glass laminate. A thickness of the web portion is at least about 10% of a thickness of the glass laminate. The method comprises expanding the cutting channel to form an expanded cutting channel and reduce the thickness of the web portion to form a reduced web portion with a thickness of at least about 0.1% of the thickness of the glass laminate. The method comprises severing the reduced web portion to form a glass laminate segment. The forming the cutting channel comprises a single pass with a first cutting tool. The expanding the cutting channel comprises a single pass with a second cutting tool.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 is a schematic cross-sectional view of embodiments of a glass laminate.

FIG. 2 is an exploded schematic cross-sectional view of embodiments of the glass laminate shown in FIG. 1 in which the non-glass substrate comprises a plurality of polymer impregnated papers.

FIG. 3 is a schematic view of the glass laminate of FIG. 1 with a relief channel formed therein.

FIG. 4 is a schematic cross-sectional view taken along line A-A of FIG. 3.

FIG. 5 is a schematic view of the glass laminate of FIG. 1 with the relief channel formed therein and a cutting path shown thereon.

FIG. 6 is a schematic view of the glass laminate after cutting the glass laminate along the cutting path shown in FIG. 5.

FIGS. 7-9 are schematic cross-sectional views taken along line B-B of FIG. 6 at varying steps of embodiments of a multi-step cutting process.

FIG. 10 is a schematic view of the glass laminate of FIG. 1 with a relief channel formed therein after cutting the glass laminate along a portion of a cutting path.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Ranges can be expressed herein as from “about” a particular value, to “about” a particular value, at least “about” a particular value, and/or at most “about” a particular value. In such cases, other embodiments include from the particular value, to the particular value, at least the particular value, and/or at most the particular value. Similarly, when values are expressed as approximations (e.g., by use of the antecedent “about”, “approximately”, or the like), it will be understood that the particular value forms another embodiment. It will be further understood that an endpoint of each range is significant both in relation to another endpoint, and independently of another endpoint.

In various embodiments, a method comprises cutting a glass laminate along a cutting path to form a glass laminate segment with a perimeter at least partially defined by the cutting path. The glass laminate comprises a glass sheet laminated to a non-glass substrate. The method comprises forming a relief channel in a glass laminate or the glass laminate comprises a relief channel formed therein. The relief channel comprises a first segment and a second segment. In some embodiments, the first segment of the relief channel is aligned with a final segment of the cutting path. Additionally, or alternatively, the second segment of the relief channel extends away from the final segment of the cutting path and is disposed outside of the glass laminate segment. In some embodiments, a depth of the relief channel, measured from a glass surface of the glass laminate, is about 30% to about 70% of a thickness of the glass laminate. Additionally, or alternatively, the second segment of the relief channel extends from the first segment of the relief channel, and an angle α between the first segment of the relief channel and the second segment of the relief channel is about 30° to about 150°. The methods described herein can enable cutting the glass laminate without cracking a portion of the glass sheet disposed in the glass laminate segment. For example, cracks that form in the glass sheet during cutting can travel away from the glass laminate segment toward the second segment of the relief channel that is disposed outside of the glass laminate segment. Thus, the relief channel can be configured to direct cracks that form in the glass sheet during cutting away from the glass laminate segment to enable a finished part that is free or substantially free of such cracks.

In various embodiments, a method comprises forming a cutting channel in a glass laminate comprising a glass sheet laminated to a non-glass substrate. The cutting channel defines a first region of the glass laminate and a second region of the glass laminate coupled to each other by a web portion disposed between the cutting channel and a surface of the glass laminate. A thickness of the web portion is at least about 10% of a thickness of the glass laminate. The method comprises expanding the cutting channel to form an expanded cutting channel and reduce the thickness of the web portion to form a reduced web portion with a thickness of at least about 0.1% of the thickness of the glass laminate. The method comprises severing the reduced web portion to form a glass laminate segment. In some embodiments, the forming the cutting channel comprises a single pass with a first cutting tool and/or the expanding the cutting channel comprises a single pass with a second cutting tool.

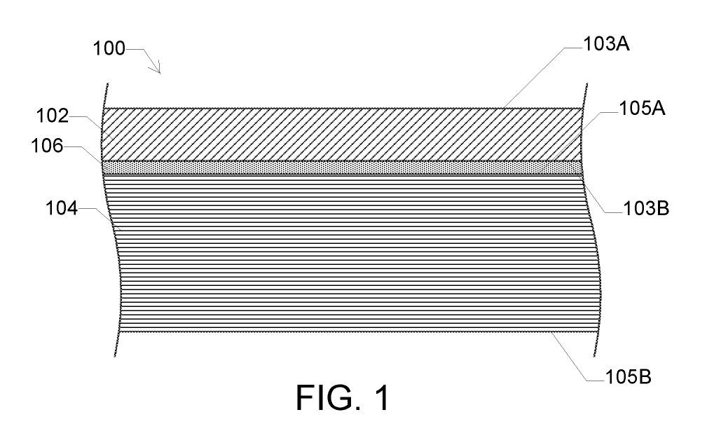

FIG. 1 is a schematic cross-sectional view of embodiments of a glass laminate 100. Glass laminate 100 comprises a glass sheet 102 laminated to a non-glass substrate 104. Glass sheet 102 comprises a first surface 103A and a second surface 103B opposite the first surface. Non-glass substrate 104 comprises a first surface 105A and a second surface 105B opposite the first surface. In some embodiments, glass sheet 102 is laminated to first surface 105A of non-glass substrate 104. For example, second surface 103B of glass sheet 102 is disposed adjacent (e.g., directly adjacent or with an intervening adhesive material) first surface 105A of non-glass substrate 104. In some embodiments, glass sheet 102 is laminated to non-glass substrate 104 with an adhesive 106 as shown in FIG. 1. Thus, glass sheet 102 is bonded to non-glass substrate 104 with adhesive 106. In other embodiments, the adhesive is omitted such that the glass sheet is laminated directly to the non-glass substrate. For example, the glass sheet can be laminated directly to a non-glass substrate comprising a polymer, binder, or resin as described herein. Thus, the glass sheet is bonded to the non-glass substrate with the polymer, binder, or resin of the non-glass substrate.

In various embodiments, glass sheet 102 is formed from or comprises a glass material, a ceramic material, a glass-ceramic material, or a combination thereof. For example, glass sheet 102 is a flexible glass sheet commercially available under the trade name Corning® Willow® Glass (Corning Incorporated, Corning, N.Y., USA) or a chemically strengthened glass sheet commercially available under the trade name Corning® Gorilla® Glass (Corning Incorporated, Corning, N.Y., USA). Glass sheet 102 can be formed using a suitable forming process such as, for example, a downdraw process (e.g., a fusion draw process or a slot draw process), a float process, an updraw process, or a rolling process. Glass sheets produced using a fusion draw process generally have surfaces with superior flatness and smoothness when compared to glass sheets produced by other methods. The fusion draw process is described in U.S. Pat. Nos. 3,338,696 and 3,682,609, each of which is incorporated by reference herein in its entirety.

In some embodiments, glass sheet 102 comprises anti-microbial properties. For example, glass sheet 102 comprises a sufficient silver ion concentration at the surface of the glass sheet to exhibit anti-microbial properties (e.g., in the range from greater than 0 to 0.047 μg/cm²) as described in U.S. Patent Application Publication No. 2012/0034435, which is incorporated by reference herein in its entirety. Additionally, or alternatively, glass sheet 102 is coated with a glaze comprising silver, or otherwise doped with silver ions, to exhibit anti-microbial properties as described in U.S. Patent Application Publication No. 2011/0081542, which is incorporated by reference herein in its entirety. In some embodiments, glass sheet 102 comprises about 50 mol % SiO₂, about 25 mol % CaO, and about 25 mol % Na₂O to exhibit anti-microbial properties.

In some embodiments, a thickness of glass sheet 102 (e.g., a distance between first surface 103A and second surface 103B) is at least about 0.01 mm, at least about 0.02 mm, at least about 0.03 mm, at least about 0.04 mm, at least about 0.05 mm, at least about 0.06 mm, at least about 0.07 mm, at least about 0.08 mm, at least about 0.09 mm, at least about 0.1 mm, at least about 0.2 mm, at least about 0.3 mm, at least about 0.4 mm, or at least about 0.5 mm. Additionally, or alternatively, a thickness of glass sheet 102 is at most about 3 mm, at most about 2 mm, at most about 1 mm, at most about 0.7 mm, at most about 0.5 mm, at most about 0.3 mm, at most about 0.2 mm, or at most about 0.1 mm. In some embodiments, glass sheet 102 is a flexible glass sheet. For example, the thickness of glass sheet 102 is at most about 0.3 mm. Additionally, or alternatively, glass sheet 102 is a strengthened glass sheet (e.g., a thermally tempered or chemically strengthened glass sheet). For example, the thickness of glass sheet 102 is about 0.4 mm to about 3 mm, about 0.3 mm to about 3 mm, about 0.2 mm to about 3 mm, about 0.1 mm to about 3 mm, or about 0.05 mm to about 3 mm.

In various embodiments, non-glass substrate 104 is formed from or comprises primarily non-glass materials. For example, non-glass substrate 104 comprises wood-based materials (e.g., wood, chipboard, particleboard, fiberboard, hardboard, cardboard, and/or paper), polymeric materials, and/or metal materials. In some embodiments, non-glass substrate 104 comprises glass, glass-ceramic, and/or ceramic materials as secondary constituents (e.g., fillers). However, in such embodiments, non-glass substrate 104 is free of glass, glass-ceramic, or ceramic sheets (e.g., solid or substantially solid sheets as opposed to fibrous mats or weaves).

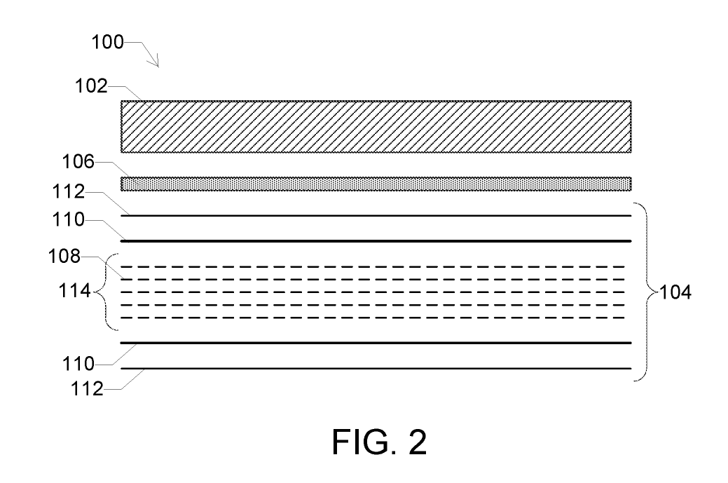

In some embodiments, non-glass substrate 104 is formed from or comprises one or more layers of polymer-impregnated paper. For example, FIG. 2 is an exploded schematic cross-sectional view of embodiments of glass laminate 100 in which non-glass substrate 104 comprises a plurality of polymer impregnated papers. In some embodiments, the plurality of polymer impregnated papers is a high pressure laminate (HPL) material, a low pressure laminate (LPL) material, or a continuous pressure laminate (CPL) material. For example, the plurality of polymer impregnated papers comprises one or more core papers 108, one or more decorative papers 110, and/or one or more surface papers 112. In some embodiments, core papers 108 are kraft papers impregnated with a phenolic resin. Core papers 108 form a core 114 of non-glass substrate 104, which can comprise a majority of a thickness of the non-glass substrate as shown in FIG. 2. Additionally, or alternatively, a decorative paper 110 is disposed on an outer surface of core 114 of non-glass substrate 104. In some embodiments, decorative paper 110 comprises a pair of decorative papers, and one of the pair of decorative papers is disposed on each of opposing outer surfaces of core 114 as shown in FIG. 2. In some embodiments, decorative papers 110 comprise a decoration that is visible through glass sheet 102 or at a non-glass surface of glass laminate 100 opposite the glass sheet. For example, the decoration comprises a solid color, a decorative pattern, or an image (e.g., printed on outer surfaces of the decorative papers). In some embodiments, decorative papers 110 are kraft papers impregnated with a phenolic resin and/or a melamine resin. Additionally, or alternatively, a surface paper 112 is disposed on an outer surface of decorative paper 110. In some embodiments, surface paper 112 comprises a pair of surface papers, and one of the pair of surface papers is disposed on an outer surface of each of the pair of decorative papers as shown in FIG. 2. Thus, each of the pair of decorative papers 110 is disposed between the respective surface paper 112 and core 114. In some embodiments, surface papers 112 are tissue or kraft papers impregnated with a melamine resin. Surface papers 112 can be sufficiently thin that the underlying decorative papers 110 are visible through the surface papers, but sufficiently resilient to protect the underlying decorative papers. The plurality of polymer impregnated papers can be pressed at elevated temperature and pressure to cure the polymer and form the non-glass substrate.

Surface papers 112 impregnated with melamine resin can provide a damage-resistant surface that can help to protect the underlying decorative papers 110. Thus, in embodiments in which the decorative paper is impregnated with a melamine resin, the respective surface layer can be omitted. Additionally, or alternatively, the surface layer that would otherwise be disposed between the glass sheet and the core of the non-glass substrate can be omitted because the glass sheet can serve as the protective layer for the underlying decorative paper. Thus, in some embodiments, the glass laminate comprises a surface layer disposed at the non-glass surface of the non-glass substrate remote from the glass sheet and is free of a surface layer disposed at the glass surface of the non-glass substrate closest to the glass sheet.

In some embodiments, the non-glass substrate comprises a functional layer in addition to the polymer impregnated papers. For example, the functional layer comprises one or more moisture barrier layers embedded within the polymer impregnated papers to prevent moisture from penetrating into the non-glass substrate. The moisture barrier layers can be formed from or comprise a metal, a polymer, or combinations thereof.

In some embodiments, a thickness of non-glass substrate 104 (e.g., a distance between first surface 105A and second surface 105B) is at least about 1 mm, at least about 2 mm, at least about 3 mm, at least about 4 mm, at least about 5 mm, at least about 6 mm, at least about 7 mm, at least about 8 mm, at least about 9 mm, or at least about 10 mm. Additionally, or alternatively, the thickness of non-glass substrate 104 is at most about 100 mm, at most about 90 mm, at most about 80 mm, at most about 70 mm, at most about 60 mm, at most about 50 mm, at most about 40 mm, at most about 30 mm, at most about 29 mm, at most about 28 mm, at most about 27 mm, at most about 26 mm, at most about 25 mm, at most about 24 mm, at most about 23 mm, at most about 22 mm, at most about 21 mm, or at most about 20 mm.

Although non-glass substrate 104 described with reference to FIG. 2 comprises a plurality of polymer impregnated papers, other embodiments are included in this disclosure.

For example, in other embodiments, the non-glass substrate is formed from or comprises a wood-based material comprising wood fragments dispersed in a binder. In some of such embodiments, the wood fragments comprise wood particles, wood chips, and/or wood fibers. Additionally, or alternatively, the binder comprises a resin that binds the wood fragments. For example, in some embodiments, the resin comprises a urea-formaldehyde (UF) resin, a phenol formaldehyde (PF) resin, a melamine-formaldehyde (MF) resin, a methylene diphenyl diisocyanate (MDI) resin, a polyurethane (PU) resin, a compatible mixture thereof, or a compatible combination thereof. In some embodiments, the non-glass substrate is a chipboard material, a fiberboard material (e.g., particleboard, medium density fiberboard (MDF), or hardboard), or a plywood material. For example, the non-glass substrate is a wood-based panel such as a chipboard panel, a fiberboard panel (e.g., a particleboard panel, a MDF panel, or a hardboard panel), or a plywood panel. The wood fragments and binder can be pressed at elevated temperature and pressure to cure the binder and form the non-glass substrate.

Also for example, in other embodiments, the non-glass substrate is formed from or comprises a polymeric material. In some of such embodiments, the polymeric material comprises polyethylene terephthalate (PET), polyethylene naphthalate (PEN), ethylene tetrafluoroethylene (ETFE), thermopolymer polyolefin (TPO™—polymer/filler blends of polyethylene, polypropylene, block copolymer polypropylene (BCPP), or rubber), polyester, polycarbonate, polyvinylbuterate, polyvinyl chloride (PVC), polyethylene or substituted polythyelene, polyhydroxybutyrate, polyhydroxyvinylbutyrate, polyvinylacetylene, transparent thermoplastic, transparent polybutadiene, polycyanoacrylate, cellulose-based polymer, polyacrylate, polymethacrylate, polyvinylalcohol (PVA), polysulphide, polyvinyl butyral (PVB), poly(methyl methacrylate) (PMMA), polysiloxane, or combinations thereof.

In some embodiments, the non-glass substrate comprises a decoration that is visible through the glass sheet or at a non-glass surface of the glass laminate opposite the glass sheet. For example the decoration comprises a decorative layer (e.g., a decorative paper or polymer), ink or paint, or a veneer disposed at an outer surface of the non-glass substrate. Additionally, or alternatively, the non-glass substrate comprises a combination of materials described herein (e.g., polymer impregnated papers, wood-based material, and/or polymeric material).

In various embodiments, adhesive 106 is formed from or comprises a polymeric material. In some embodiments, the polymeric material is selected from the group consisting of a silicone, an acrylate (e.g., polymethyl methacrylate (PMMA)), a polyurethane polyvinylbutyrate, an ethylenevinylacetate, an ionomer, a polyvinyl butyral, compatible mixtures thereof, and compatible combinations thereof. For example, adhesive 106 comprises DuPont SentryGlas®, DuPont PV 5411, Japan World Corporation material FAS, or polyvinyl butyral resin. In some embodiments, adhesive 106 comprises a thermoplastic polymer material. Additionally, or alternatively, adhesive 106 is a sheet or film of adhesive. In some of such embodiments, adhesive 106 comprises a decorative pattern or design visible through glass sheet 102. In some embodiments, adhesive 106 comprises a functional component that exhibits, for example, color, decoration, heat or UV resistance, IR filtration, or combinations thereof. Additionally, or alternatively, adhesive 106 is optically clear on cure, translucent, or opaque.

In some embodiments, a thickness of adhesive 106 (e.g., a distance between second surface 103B of glass sheet 102 and first surface 105A of non-glass substrate 104) is at most about 5000 μm, at most about 1000 μm, at most about 500 μm, at most about 250 μm, at most about 50 μm, at most about 40 μm, at most about 30 μm, or at most about 25 μm. Additionally, or alternatively, the thickness of adhesive 106 is at least about 5 μm, at least about 10 μm, at least about 15 μm, at least about 20 μm, at least about 50 μm, or at least about 100 μm.

In some embodiments, glass laminate 100 comprises a single glass sheet 102. For example, glass laminate 100 is free of a glass sheet laminated to second surface 105B of non-glass substrate. In some of such embodiments, second surface 105B of non-glass substrate 104 is an exterior surface of glass laminate 100.

Although glass laminate 100 shown in FIGS. 1-2 comprises a single glass sheet 102 laminated to first surface 105A of non-glass substrate 104, other embodiments are included in this disclosure. For example, in other embodiments, a glass laminate comprises a second glass sheet laminated to the second surface of the non-glass substrate (e.g., opposite first surface 105A of non-glass substrate 104). Thus, the non-glass substrate is disposed between the glass sheet and the second glass sheet. Each glass sheet can be laminated to the non-glass substrate as described herein with reference to glass sheet 102 and non-glass substrate 104.

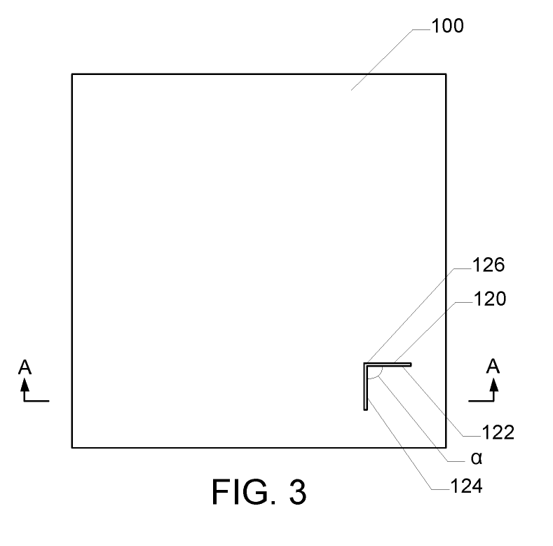

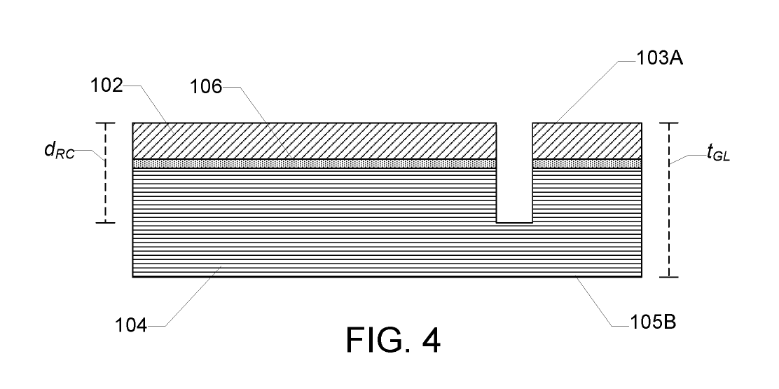

FIGS. 3-6 illustrate exemplary methods for cutting a glass laminate to form a segmented glass laminate. In some embodiments, the method comprises forming a relief channel in the glass laminate. For example, FIG. 3 is a schematic view of glass laminate 100 with a relief channel 120 formed therein, and FIG. 4 is a schematic cross-sectional view taken along line A-A of FIG. 3. Relief channel 120 comprises a channel or groove formed in glass laminate 100 and extending from one outer surface of the glass laminate toward the opposing outer surface. For example, in the embodiments shown in FIGS. 3-4, relief channel 120 extends from first surface 103A of glass sheet 102 toward second surface 105B of non-glass substrate 104. Thus, relief channel 120 extends from a glass surface (e.g., first surface 103A) of glass laminate 100 toward a non-glass surface (e.g., second surface 105B) of the glass laminate. In other embodiments, the relief channel extends from a non-glass surface toward a glass surface or from one glass surface toward another glass surface. In some embodiments, a depth d_{RC} of relief channel 120, measured from an outer surface of glass laminate 100, is about 30% to about 70% of a thickness t_{GL} of the glass laminate. For example, depth d_{RC} of relief channel 120, measured from the glass surface of glass laminate 100, is about 30% to about 70% of a thickness t_{GL} of the glass laminate. In some embodiments, depth d_{RC} is at least about 30%, at least about 40%, or at least about 50% of thickness t_{GL}. Additionally, or alternatively, depth d_{RC} is at most about 70%, at most about 60%, or at most about 50% of thickness t_{GL}. Additionally, or alternatively, relief channel 120 extends entirely through glass sheet 102. The relief channel depth within the ranges described herein can enable cutting the glass laminate while avoiding forming cracks in the glass sheet. Without wishing to be bound by any theory, it is believed that the relief channel depth described herein is sufficiently deep to provide adequate stress relief during cutting and sufficiently shallow to avoid potentially damaging vibration of the glass sheet during cutting. In some embodiments, the depth of relief channel 120 is substantially constant along the length of the relief channel. Thus, the depth of first segment 122 is substantially equal to the depth of second segment 124. In other embodiments, the depth of the relief channel varies along the length of the relief channel. For example, the depth of the first segment is different than the depth of the second segment.

In some embodiments, relief channel 120 comprises a first segment 122 and a second segment 124. First segment 122 and second segment 124 of relief channel 120 intersect one another at a relief intersection 126. Thus, first segment 122 and second segment 124 cooperatively define relief channel 120. In some embodiments, an end of first segment 122 is disposed at intersection 126. Additionally, or alternatively, an end of second segment 124 is disposed at intersection 126. For example, in the embodiments shown in FIGS. 3-4, an end of each of first segment 122 and second segment 124 of relief channel 120 is disposed at intersection 126. Thus, each of first segment 122 and second segment 124 of relief channel 120 extends from intersection 126. In other embodiments, an intermediate point of the first segment and/or the second segment of the relief cannel is disposed at the relief intersection. For example, the intermediate point is disposed between opposing ends of the respective first segment or second segment of the relief channel such that different portions of the respective segment lie on opposing sides of the relief intersection.

In some embodiments, first segment 122 is substantially linear. Additionally, or alternatively, second segment 124 is substantially linear. For example, in the embodiments shown in FIGS. 3-4, each of first segment 122 and second segment 124 of relief channel 120 is substantially linear. In other embodiments, the first segment and/or the second segment of the relief channel can be an arc, a curve, or another shape.

In some embodiments, a length of first segment 122 and/or second segment 124 of relief channel 120 (e.g., a distance between opposing ends of the respective relief channel) is about 10 mm to about 60 mm. In some embodiments, the length of first segment 122 and/or second segment 124 is at least about 10 mm, at least about 15 mm, at least about 20 mm, at least about 25 mm, or at least about 30 mm. Additionally, or alternatively, the length of first segment 122 and/or second segment 124 is at most about 60 mm, at most about 55 mm, at most about 50 mm, at most about 45 mm, at most about 40 mm, at most about 35 mm, or at most about 30 mm. If the length of the respective segment of the relief channel is too small, the relief channel may not provide sufficient stress relief to avoid cracking in the glass sheet. If the length of the respective segment of the relief channel is too large, the relief channel may render a large portion of the glass sheet unusable and/or take an excessive amount of time to form. In some embodiments, the length of first segment 122 is substantially equal to the length of second segment 124 as shown in FIGS. 3-4. In other embodiments, the length of the first segment is different than the length of the second segment.

In some embodiments, a width of first segment 122 and/or second segment 124 of relief channel 120 (e.g., a distance between opposing edges of the respective relief channel) is about 4 mm to about 10 mm. The width of the relief channel may be determined by the size of the tool (e.g., the router bit as described herein) used to form the relief channel. If the tool is too small, the tool is more likely to break while forming the relief channel. If the tool is too large, the tool may produce large chips while forming the relief channel and/or crack the glass sheet. In some embodiments, the width of relief channel 120 is substantially constant along the length of the relief channel. Thus, the width of first segment 122 is substantially equal to the width of second segment 124 as shown in FIGS. 3-4. In other embodiments, the width of the relief channel varies along the length of the relief channel. For example, the width of the first segment is different than the width of the second segment.

In some embodiments, an angle α between first segment 122 and second segment 124 is about 30° to about 150°. In some embodiments, angle α is at least about 30°, at least about 35°, at least about 40°, at least about 45°, at least about 50°, at least about 55°, at least about 60°, at least about 65°, at least about 70°, at least about 75° at least about 80°, or at least about 85°. Additionally, or alternatively, angle α is at most about 150°, at most about 145°, at most about 140°, at most about 135°, at most about 130°, at most about 125°, at most about 120°, at most about 115°, at most about 110°, at most about 105° at most about 100°, or at most about 95°. For example, in the embodiments shown in FIGS. 3-4, angle α is about 90°. Thus, relief channel 120 is substantially L-shaped, with each of first segment 122 and second segment 124 defining a leg of the L-shaped relief channel. In some embodiments, angle α is the smallest angle disposed between a longest portion of first segment 122 and a longest portion of second segment 124, with the longest portion of the respective segment of relief channel 120 being the portion of the segment extending between intersection 126 and an end of the segment having the greatest length. In some embodiments, an end of first segment 122 and/or second segment 124 is disposed at intersection 126 such that the first segment and/or the second segment comprises a single portion, which is the longest portion of the respective segment. For example, in the embodiments shown in FIGS. 3-4, an end of each of first segment 122 and second segment 124 is disposed at intersection 126, such that each of the first segment and the second segment comprises a single portion, which is the longest portion.

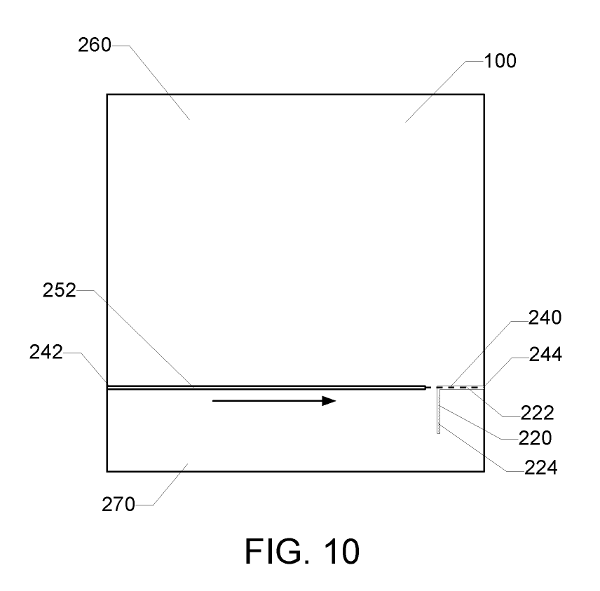

In some embodiments, relief channel 120 is spaced from an edge of glass laminate 100. For example, relief channel 120 is spaced from each edge of glass laminate 100 such that the relief channel is disposed in a central region of the glass laminate. In some of such embodiments, relief channel 120 is spaced from each edge of glass laminate 100 by at least about 5 mm, or at least about 10 mm. The upper limit of the spacing can be determined by the size of the glass laminate and the size of the glass laminate segment to be cut therefrom. For example, the relief channel is disposed close enough to the edges of the glass laminate that there is sufficient space to cut the glass laminate segment from the glass laminate as described herein. Larger spacing can help to prevent uncontrolled fracture of glass layer 102 during cutting of glass laminate, which can be more likely to occur near the edges of the glass laminate. However, smaller spacing can help to reduce the amount of the glass sheet that is unusable following cutting, which can improve efficiency of using the glass laminate. In other embodiments, the relief channel is disposed at an edge of the glass laminate (e.g., as described herein in reference to FIG. 10).

In some embodiments, forming relief channel 120 comprises forming the relief channel using a mechanical cutting process. For example, forming relief channel 120 comprises forming the relief channel using a mechanical cutting tool such as a router, a saw, or another cutting tool. In some embodiments, forming relief channel 120 comprises forming the relief channel using a computer numerical control (CNC) machine. For example, the mechanical cutting tool is mounted on the CNC machine such that the CNC machine controls movement of the mechanical cutting tool to form relief channel 120. In other embodiments, forming relief channel 120 comprises forming the relief channel using a handheld tool. For example, the mechanical cutting tool is a handheld tool. In yet other embodiments, forming relief channel 120 comprises forming the relief channel using a fluid jet, a laser, or another suitable cutting device.

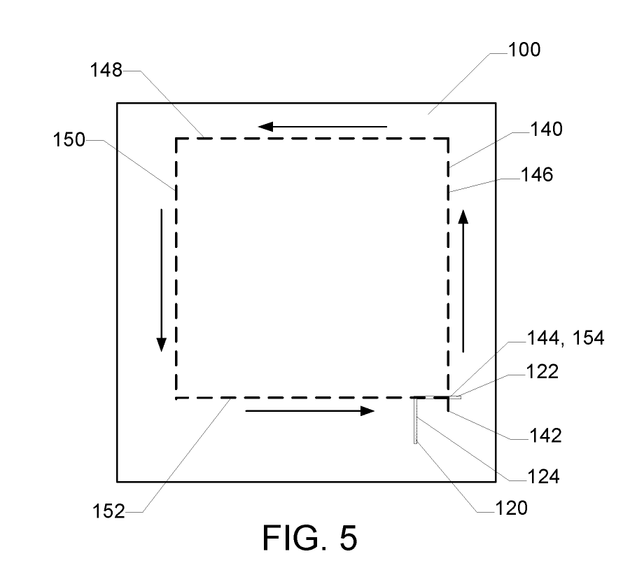

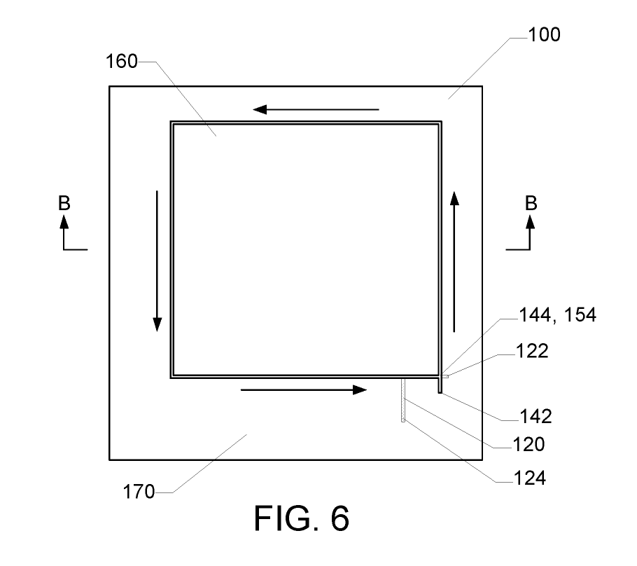

In some embodiments, the method comprises cutting the glass laminate along a cutting path to form a glass laminate segment. For example, FIG. 5 is a schematic view of glass laminate 100 with relief channel 120 formed therein and a cutting path 140 shown thereon, and FIG. 6 is a schematic view of the glass laminate after cutting the glass laminate along the cutting path shown in FIG. 5. Cutting path 140 is a path along which glass laminate 100 is intended to be severed to form a glass laminate segment comprising a perimeter at least partially defined by the cutting path as described herein. Cutting path 140 extends from an initiation point 142 to a termination point 144. Glass laminate 100 can be severed along cutting path 140 starting at initiation point 142 and ending at termination point 144 (e.g., as shown by the arrows in FIG. 5) to form the glass laminate segment. In some embodiments, cutting path 140 comprises a plurality of segments. For example, cutting path 140 shown in FIG. 5 comprises an initial segment 146, a first intermediate segment 148, a second intermediate segment 150, and a final segment 152, each of which is substantially linear. In some embodiments, cutting path 140 comprises a closed loop defining the perimeter of the glass laminate segment. For example, the plurality of segments of cutting path 140 shown in FIG. 5 is arranged such that final segment 152 intersects initial segment 146 (e.g., termination point 144 is disposed on the initial segment), and the plurality of segments cooperatively defines a closed loop having a rectangular shape.

In some embodiments, first segment 122 of relief channel 120 is aligned with final segment 152 of cutting path 140. For example, at least a portion of final segment 152 of cutting path 140 overlaps or extends along at least a portion of first segment 122 of relief channel 120. Additionally, or alternatively, second segment 124 of relief channel 120 extends away from final segment 152 of cutting path. For example, final segment 152 of cutting path 140 extends through an end of second segment 124 of relief channel 120 and/or relief intersection 126 such that the second segment of the relief channel extends away from the final segment of the cutting path.

In some embodiments, an initial segment of the cutting path intersects the first segment of the relief channel at a cutting intersection. For example, in the embodiments shown in FIG. 5, initial segment 146 of cutting path 140 intersects first segment 122 of relief channel 120 at cutting intersection 154. Additionally, or alternatively, cutting intersection 154 is disposed at termination point 144. Such an arrangement helps to enable alignment of the final segment of the cutting path with the first segment of the relief channel as described herein as well as the closed loop configuration of the cutting path also as described herein.

In some embodiments, cutting the glass laminate along the cutting path forms a glass laminate segment. For example, in the embodiments shown in FIG. 6, glass laminate 100 has been cut along cutting path 140 (e.g., from initiation point 142 to termination point 144 in the direction of the arrows shown in FIGS. 5-6) to form glass laminate segment 160. During the cutting, glass laminate 100 is severed such that glass laminate segment 160 is separated from a remaining portion 170 of the glass laminate. For example, remaining portion 170 is the portion of glass laminate 100 disposed outside of the closed loop defined by cutting path 140. In some embodiments, remaining portion 170 of glass laminate 100 is scrap or waste material. In other embodiments, remaining portion 170 of glass laminate 100 can be cut to separate further glass laminate segments therefrom.

Although remaining portion 170 described with reference to FIG. 6 is disposed outside of the closed loop defined by cutting path 140, other embodiments are included in this disclosure. In other embodiments, The glass laminate segment is disposed outside the cutting path, and the remaining portion is disposed inside the cutting path. In some of such embodiments, the second segment of the relief channel extends inward into the closed loop defined by the cutting path.

The configuration of the relief channel and the arrangement of the cutting path relative to the relief channel can enable precise cutting of the glass laminate to form the glass laminate segment without undesirable cracking of the glass sheet. For example, as the glass laminate is severed along the final segment of the cutting path toward the relief channel, cracks may form in the glass laminate. However, the configuration of the relief channel and orientation relative to the cutting path can help to direct any cracks that form in the glass sheet away from the glass laminate segment and toward the second segment of the relief channel. Thus, any cracks that form in the glass laminate will tend to be disposed in the remaining portion of the glass laminate as opposed to the glass laminate segment. For example, the cracks tend to be directed away from the finished part.

In some embodiments, glass laminate segment 160 comprises a perimeter at least partially defined by cutting path 140. For example, in the embodiments shown in FIGS. 5-6, glass laminate segment 160 comprises a perimeter with a rectangular shape corresponding to the rectangular shape defined by cutting path 140. In some embodiments, cutting path 140 comprises a closed loop such that the entire perimeter of glass laminate segment 160 is defined by cutting path 140. In other embodiments, the cutting path does not comprise a closed loop (e.g., as described herein in reference to FIG. 10) such that less than the entire perimeter of the glass laminate segment is defined by the cutting path.

Although cutting path 140 is described in reference to FIGS. 5-6 as comprising 4 segments arranged in a rectangular shape, other embodiments are included in this disclosure. For example, in other embodiments, the cutting path comprises a single segment (e.g., as described herein in reference to FIG. 10) or another suitable number (e.g., 2, 3, 5, or more) of segments arranged in a circular, triangular, rectangular, or another polygonal or non-polygonal shape. Additionally, or alternatively, each segment can be, independently, linear, non-linear (e.g., curved), or can have linear and non-linear portions. In various embodiments, the cutting path can be configured to provide a glass laminate segment with a perimeter having a desired shape.

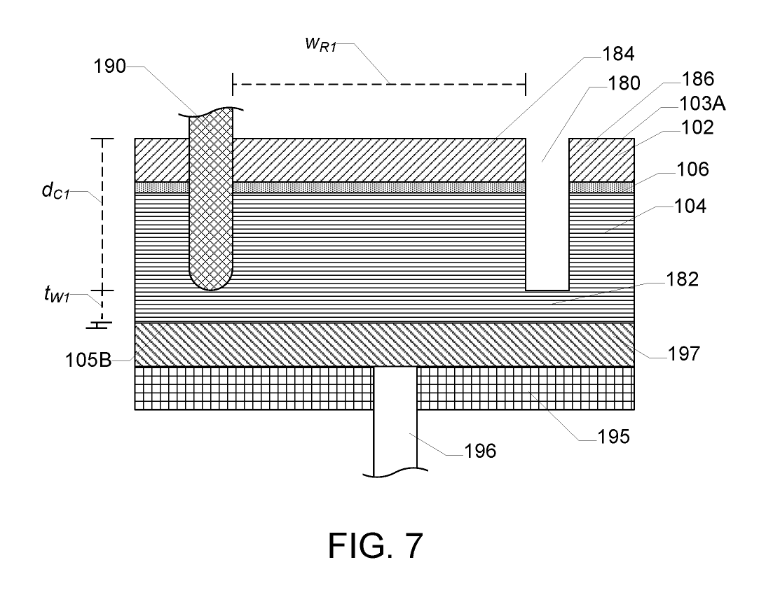

In some embodiments, cutting glass laminate 100 along cutting path 140 to form glass laminate segment 160 comprises cutting the glass laminate using a multi-step cutting process. FIGS. 7-9 are schematic cross-sectional views taken along line B-B of FIG. 6 at varying steps of embodiments of a multi-step cutting process. In some embodiments, the multi-step cutting process comprises forming a cutting channel in the glass laminate. For example, in the embodiment shown in FIG. 7, the multi-step cutting process comprises forming a cutting channel 180 in glass laminate 100. Cutting channel 180 comprises a channel or groove formed in glass laminate 100 and extending from one outer surface of the glass laminate toward the opposing outer surface. For example, in the embodiments shown in FIG. 7, cutting channel 180 extends from first surface 103A of glass sheet 102 toward second surface 105B of non-glass substrate 104. Thus, cutting channel 180 extends from a glass surface (e.g., first surface 103A) of glass laminate 100 toward a non-glass surface (e.g., second surface 105B) of the glass laminate. In other embodiments, the cutting channel extends from a non-glass surface toward a glass surface or from one glass surface to another glass surface. In some embodiments, a depth d_{C1} of cutting channel 180, measured from a glass surface of glass laminate 100, is at most about 90%, at most about 85%, at most about 80%, or at most about 75% of thickness t_{GL} of the glass laminate. Additionally, or alternatively, depth d_{C1} of cutting channel 180 is at least about 50%, at least about 60%, at least about 70%, at least about 80%, or at least about 85% of thickness t_{GL} of glass laminate 100. In some embodiments, cutting channel 180 extends entirely through glass sheet 102 of glass laminate 100. In some embodiments, a width of cutting channel 180 is at least about 3 mm, at least about 4 mm, or at least about 5 mm. Additionally, or alternatively, a width of cutting channel 180 is at most about 12 mm, at most about 10 mm, at most about 9 mm, at most about 8 mm, or at most about 7 mm. For example, in some embodiments, a width of cutting channel 180 is about 6 mm. The width of the cutting channel generally corresponds to a size of a tool (e.g., a diameter of a router bit or a width of a saw blade) used to form the cutting channel as described herein.

In some embodiments, cutting channel 180 does not extend entirely through glass laminate 100 such that a web portion 182 of the glass laminate remains disposed between the cutting channel and a surface of the glass laminate (e.g., second surface 105B of non-glass substrate 104 or first surface 103A of glass sheet 102). In such embodiments, after forming cutting channel 180, web portion 182 couples a first region 184 of glass laminate 100 and a second region 186 of the glass laminate together. For example, cutting channel 180 defines a boundary between first region 184 and second region 186. First region 184 comprises a portion of glass laminate 100 that will become glass laminate segment 160 following cutting. Second region 186 comprises a portion of glass laminate 100 that will become remaining portion 170 following cutting. In some embodiments, a thickness t_{W1} of web portion 182 is at least about 10%, at least about 15%, at least about 20%, or at least about 25% of thickness t_{GL} of glass laminate 100. Additionally, or alternatively, thickness t_{W1} of web portion 182 is at most about 50%, at most about 40%, at most about 30%, at most about 20%, or at most about 15% of thickness t_{GL} of glass laminate 100. In some embodiments, a dimension w_{R1} of first region 184 is slightly larger than a corresponding dimension of glass laminate segment 160. For example, in the embodiments shown in FIG. 7, dimension w_{R1} is a width of first region 184 and slightly larger than the corresponding width of glass laminate segment 160. In some embodiments, dimension w_{R1} of first region 184 is at least about 0.1 mm, at least about 0.2 mm, at least about 0.3 mm, at least about 0.4 mm, at least about 0.5 mm, at least about 1 mm, at least about 2 mm, or at least about 3 mm larger than the corresponding dimension of glass laminate segment. Additionally, or alternatively, dimension w_{R1} of first region 184 is at most about 10 mm, at most about 9 mm, at most about 8 mm, at most about 7 mm, at most about 6 mm, or at most about 5 mm larger than the corresponding dimension of glass laminate segment. In various embodiments, the dimension can be a width, a length, a diameter, or another dimension.

In some embodiments, forming cutting channel 180 comprises forming the cutting channel with a mechanical cutting tool. For example, in the embodiments shown in FIG. 7, forming cutting channel 180 comprises forming the cutting channel with a router bit 190. In some embodiments, router bit 190 is a single flute, downward cut, spiral router bit. In various embodiments, the router bit can have 1, 2, 3, or more flutes. Additionally, or alternatively, the router bit can be downward cut, upward cut, or compression cut. In some embodiments, a diameter of router bit 190 corresponds to a width of cutting channel 180. For example, the diameter of router bit 190 can be any of the sizes described herein with respect to the width of cutting channel 180. In some embodiments, the diameter of router bit 190 is about 6 mm to about 10 mm. The diameter of router bit 190 and the configuration of cutting path 140 can be determined such that dimension w_{R1} of first region 184 is slightly larger than the corresponding dimension of glass laminate segment 160 as described herein. In other embodiments, forming cutting channel 180 comprises forming the cutting channel using a fluid jet, a laser, or another suitable cutting device.

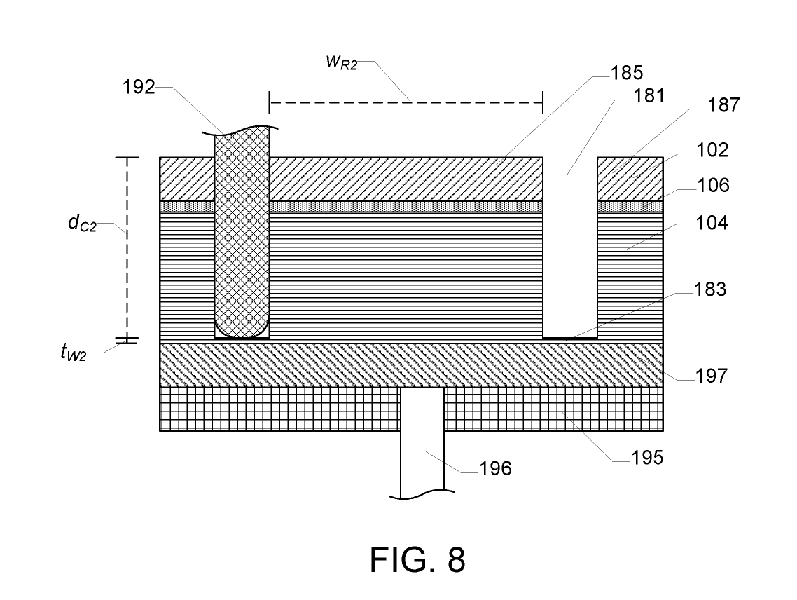

In some embodiments, the multi-step cutting process comprises expanding the cutting channel in the glass laminate to form an expanded cutting channel. For example, in the embodiments shown in FIG. 8, the multi-step cutting process comprises expanding cutting channel 180 previously formed in glass laminate 100 to form expanded cutting channel 181. In some embodiments, expanding cutting channel 180 comprises increasing the depth and/or the width of the cutting channel to form expanded cutting channel 181. For example, expanding cutting channel 180 comprises increasing the depth of the cutting channel from depth d_{C1} to a depth d_{C2} of expanded cutting channel 181. In some embodiments, depth d_{C2} of expanded cutting channel 181, measured from a glass surface of glass laminate 100, is at most about 99.9% of thickness t_{GL} of the glass laminate. Additionally, or alternatively, depth d_{C2} of expanded cutting channel 181 is at least about 50%, at least about 60%, at least about 70%, at least about 80%, at least about 90%, at least about 95%, at least about 96%, at least about 97%, at least about 98%, or at least about 99% of thickness t_{GL} of glass laminate 100. In some embodiments, a width of expanded cutting channel 181 is at least about 3 mm, at least about 4 mm, or at least about 5 mm. Additionally, or alternatively, a width of expanded cutting channel 181 is at most about 10 mm, at most about 9 mm, at most about 8 mm, or at most about 7 mm. For example, in some embodiments, a width of expanded cutting channel 181 is about 6.35 mm. In some embodiments, the width of expanded cutting channel 181 is at least about 0.1 mm, at least about 0.2 mm, at least about 0.3 mm, at least about 0.4 mm, at least about 0.5 mm, at least about 1 mm, at least about 1.5 mm, at least about 2 mm, at least about 2.5 mm, or at least about 3 mm larger than the width of cutting channel 180. Additionally, or alternatively, the width of expanded cutting channel 181 is at most about 10 mm larger than the width of cutting channel 180. In some embodiments, a ratio of the width of expanded cutting channel 181 to the width of cutting channel 180 is at least about 1.01, at least about 1.02, at least about 1.03, at least about 1.04, at least about 1.05, at least about 1.1, at least about 1.15, at least about 1.2, at least about 1.25, at least about 1.3, at least about 1.35, at least about 1.4, or at least about 1.45. Additionally, or alternatively, the ratio of the width of expanded cutting channel 181 to the width of cutting channel 180 is at most about 2, at most about 1.9, at most about 1.8, at most about 1.7, at most about 1.6 at most about 1.5, or at most about 1.4. The width of the expanded cutting channel generally corresponds to a size of a tool (e.g., a diameter of a router bit or a width of a saw blade) used to enlarge the cutting channel to form the expanded cutting channel as described herein.

In some embodiments, expanded cutting channel 181 does not extend entirely through glass laminate 100 such that a reduced web portion 183 of the glass laminate remains disposed between the expanded cutting channel and a surface of the glass laminate (e.g., second surface 105B of non-glass substrate 104 or first surface 103A of glass sheet 102). For example, reduced web portion 183 is formed by removing a portion of web portion 182 during the expanding cutting channel 182.

In some embodiments, expanding cutting channel 180 comprises increasing the width of the cutting channel to form expanded cutting channel 181. For example, in the embodiments shown in FIG. 8, after forming expanded cutting channel 181, reduced web portion 183 couples a reduced first region 185 of glass laminate 100 and a reduced second region 187 of the glass laminate together. For example, reduced first region 185 is formed by removing a portion of first region 184 during the expanding cutting channel 182. Additionally, or alternatively, reduced second region 187 is formed by removing a portion of second region 186 during the expanding cutting channel 182. Reduced first region 185 comprises a portion of glass laminate 100 that will become glass laminate segment 160 following cutting. Reduced second region 187 comprises a portion of glass laminate 100 that will become remaining portion 170 following cutting. In some embodiments, a thickness t_{W2} of reduced web portion 183 is at least about 0.1% of thickness t_{GL} of glass laminate 100. Additionally, or alternatively, thickness t_{W2} of reduced web portion 183 is at most about 1%, at most about 2%, at most about 3%, at most about 4%, at most about 5%, at most about 10%, at most about 20%, at most about 30%, at most about 40%, or at most about 50% of thickness t_{GL} of glass laminate 100. In some embodiments, a dimension w_{R2} of reduced first region 185 is substantially equal to a corresponding dimension of glass laminate segment 160. For example, in the embodiments shown in FIG. 8, dimension w_{R2} is a width of reduced first region 185 and substantially equal to the corresponding width of glass laminate segment 160.

In some embodiments, expanding cutting channel 180 comprises expanding the cutting channel with a mechanical cutting tool to form expanded cutting channel 181. For example, in the embodiments shown in FIG. 8, expanding cutting channel 180 comprises expanding the cutting channel with a router bit 192. Router bit 192 can be configured as described herein in reference to router bit 190, which may be used to form cutting channel 180, and can be the same as or different than router bit 190. In some embodiments, router bit 192 comprises a greater number of flutes than router bit 190. For example, in some embodiments, router bit 192 is a 6 flute, compression, spiral router bit such as the router bit commercially available as model number 46302 from Amana Tool (Farmingdale, N.Y., USA). The greater number of flutes can enable router bit 192 to generate smaller particles during the expanding cutting channel 180 than router bit 190 generates during the forming the cutting channel. In some embodiments, a diameter of router bit 192 corresponds to a width of expanded cutting channel 181. For example, the diameter of router bit 192 can be any of the sizes described herein with respect to the width of expanded cutting channel 181. The diameter of router bit 192 and the configuration of cutting path 140 can be determined such that dimension w_{R2} of reduced first region 185 is substantially equal to the corresponding dimension of glass laminate segment 160 as described herein. Thus, expanding cutting channel 180 to form expanded cutting channel 181 can trim first region 184 to form reduced first region 185 that is the same size as glass laminate segment 160.

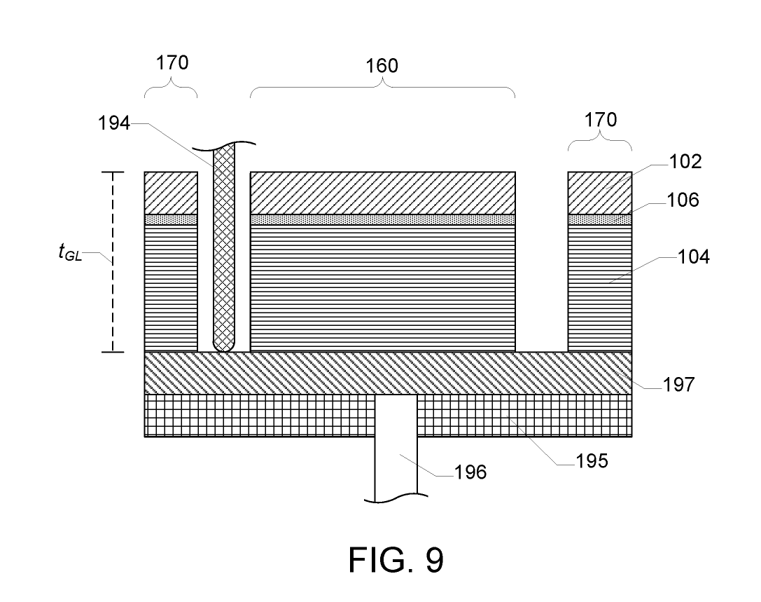

In some embodiments, the multi-step cutting process comprises severing a web portion of the glass laminate to separate the first region of the glass laminate and the second region of the glass laminate from each other and form the glass laminate segment. For example, in the embodiments shown in FIG. 9, the multi-step cutting process comprises severing reduced web portion 183 of glass laminate 100 to separate reduced first region 185 and second reduced region 187 of the glass laminate from each other and form glass laminate segment 160 and remaining portion 170. In some embodiments, the severing reduced web portion 183 comprises expanding the depth of expanded cutting channel 181 to sever the reduced web portion. For example, the severing reduced web portion 183 comprises expanding the depth of the expanded cutting channel 181 until the depth is equal to thickness t_{GL} of glass laminate 100 (e.g., until the expanded cutting channel extends entirely through the glass laminate). In some embodiments, the severing reduced web portion 183 comprises expanding the depth of the expanded cutting channel 181 without expanding the width of the expanded cutting channel. Thus, reduced first region 185 with the dimensions of glass laminate segment 160 is not further reduced during the severing reduced web portion 183. In other embodiments, the severing the reduced web portion comprises expanding the depth and the width of the expanded cutting channel. Thus, the reduced first region is further reduced during the severing the reduced web portion to trim the reduced first region to the dimensions of the glass laminate segment.

In some embodiments, severing reduced web portion 183 comprises severing the reduced web portion with a mechanical cutting tool to form glass laminate segment 160. For example, in the embodiments shown in FIG. 9, severing reduced web portion 183 comprises severing the reduced web portion with a router bit 194. Router bit 194 can be configured as described herein in reference to router bit 190 or router bit 192, which may be used to form cutting channel 180 and expanded cutting channel 181, respectively, and can be the same as or different than router bit 190 or router bit 192. In some embodiments, router bit 194 has a smaller diameter than router bit 190 and router bit 192. Such a smaller diameter router bit can enable precise removal of reduced web portion 183 with or without further reducing the reduced first portion of the glass laminate defined by the expanded cutting channel. In other embodiments, the mechanical cutting tool comprises a knife or saw blade. The relatively small thickness of reduced web portion 183 can enable cutting with a blade for reduced complexity compared to using a router bit.

In some embodiments, the forming cutting channel 180 comprises a single pass with a cutting tool as opposed to multiple passes. For example, the forming cutting channel 180 comprises plunging router bit 190 into glass laminate 100 to depth d_{C1} and moving the router bit along cutting path 140 in one, continuous pass, as opposed to multiple, progressively deeper passes. In some embodiments, the expanding cutting channel 180 to form expanded cutting channel 181 comprises a single pass with a cutting tool as opposed to multiple passes. For example, the expanding cutting channel 180 to form expanded cutting channel 181 comprises plunging router bit 192 into glass laminate 100 to depth d_{C2} and moving the router bit along cutting path 140 in one, continuous pass, as opposed to multiple, progressively deeper passes. In some embodiments, the severing reduced web portion 183 comprises a single pass with a cutting tool as opposed to multiple passes. In some embodiments, the multi-step cutting process comprises three single passes with a cutting tool (e.g., to form the cutting channel, expand the cutting channel, and sever the reduced web portion) as described herein.

The multi-step cutting process described herein can enable precise cutting of the glass laminate to form a glass laminate segment with desired dimensions with reduced cracking of the glass sheet. For example, the steps of the multi-step cutting process can become progressively finer from the relatively course forming the cutting channel to the finer expanding the cutting channel to the relatively fine severing the web to form the glass laminate segment. As the glass laminate is progressively trimmed to form the glass laminate segment with the desired dimensions, the finer cutting steps enable more precise cutting with less vibration. For example, the greater number of flutes on the router bit used to expand the cutting channel compared to the router bit used to form the cutting channel enables reduced vibration during the expanding the cutting channel compared to the forming the cutting channel, which can reduce movement of the glass sheet at the edge of the cutting channel and reduce cracking of the glass sheet.

Although the multi-step cutting process described herein in reference to FIGS. 7-9 is a 3-step process (forming cutting channel 180, expanding the cutting channel to form expanded cutting channel 181, and severing reduced web portion 183 to form glass laminate segment 160) other embodiments are included in this disclosure. For example, in other embodiments, the expanding the cutting channel to form the expanded cutting channel is omitted such that the multi-step cutting process is a 2-step process comprising forming the cutting channel and severing the web portion to form the glass laminate segment.

Although the expanding cutting channel 180 to form expanded cutting channel 181 described herein in reference to FIGS. 7-9 comprises reducing first region 184 to form reduced first region 185 and reducing second region 186 to form reduced second region 187, other embodiments are included in this disclosure. For example, in other embodiments, the expanding the cutting channel to form the expanded cutting channel comprises reducing only one of the first region or the second region such that the other of the first region or the second region remains substantially the same size.

Although the cutting glass laminate 100 along cutting path 140 to form glass laminate segment 160 described herein in reference to FIGS. 7-9 comprises cutting the glass laminate using a multi-step cutting process, other embodiments are included in this disclosure. For example, in other embodiments, the cutting the glass laminate along the cutting path to form the glass laminate segment comprises cutting the glass laminate using a single-step cutting process (e.g., with a router, a saw blade, a fluid jet, a laser, or another suitable cutting tool).

In some embodiments, cutting glass laminate 100 comprises cutting the glass laminate using a CNC machine. For example, in the embodiments shown in FIGS. 7-9, glass laminate 100 is mounted on a stage 195 of CNC machine during the cutting. The cutting tools (e.g., router bits 190, 192, and/or 194) can be mounted on a spindle of the CNC machine during the cutting. Stage 195 and the spindle of the CNC machine are movable relative to each other to control movement of the cutting tools relative to glass laminate 100. In some embodiments, glass laminate 100 is mounted on stage 195 by vacuum. For example, the CNC machine comprises a vacuum system 196 that draws a vacuum between stage 195 and glass laminate 100 to secure the glass laminate to the stage. In some embodiments, the CNC machine comprises a buffer material 197 disposed between glass laminate 100 and stage 195. For example, in the embodiments shown in FIGS. 7-9, buffer material 197 comprises medium density fiberboard (MDF) material. The MDF material can be a sacrificial layer. For example, during the cutting, the cutting tool used to cut glass laminate 100 can cut into the MDF material without damaging underlying stage 195. In some embodiments, buffer material 197 is a porous material to enable the vacuum to be drawn between glass laminate and stage 195.

In some embodiments, the method comprises applying a protective film to the surface of the glass laminate (e.g., a glass surface of the glass laminate) prior to the cutting step. For example, the protective film comprises a protective tape extending along the cutting path. The protective film can help to avoid cracking of the glass sheet during the cutting.

FIG. 10 is a schematic view of glass laminate 100 with other embodiments of a relief channel 220 formed therein after cutting the glass laminate along a portion of a cutting path 240. Relief channel 220 is similar to relief channel 120 described herein in reference to FIG. 3, except that relief channel 220 is disposed at an edge of glass laminate 100 instead of a central region of the glass laminate. For example, in the embodiments shown in FIG. 10, relief channel 220 comprises a first segment 222 and a second segment 224, and the first segment intersects the edge of glass laminate 100.

Cutting path 240 extends from an initiation point 242 to a termination point 244. In the embodiments shown in FIG. 10, initiation point 242 is disposed at an edge of glass laminate 100 opposite relief channel 220, and termination point is disposed at the relief channel and at the edge of the glass laminate. Glass laminate 100 can be severed along cutting path 240 starting at initiation point 242 and ending at termination point 244 (e.g., as shown by the arrow in FIG. 10) to form glass laminate segment 260. In some embodiments, cutting path 240 comprises a single segment. The single segment defines a portion of the perimeter of glass laminate segment 260. For example, the single of segment of cutting path 240 shown in FIG. 10 defines one edge of glass laminate segment 260 having a rectangular shape, with the remaining 3 edges of the perimeter of glass laminate segment 260 defined by edges of glass laminate 100. In some embodiments, first segment 222 of relief channel 220 is aligned with final segment 252 of cutting path 240 as described herein in reference to FIGS. 5-6.

In some embodiments, cutting the glass laminate along the cutting path forms a glass laminate segment. For example, in the embodiments shown in FIG. 10, glass laminate 100 has been cut along a portion of cutting path 240 (e.g., from initiation point 242 toward termination point 244 in the direction of the arrow shown in FIG. 10) in the process of forming glass laminate segment 260. Thus, the cutting extends from a first edge of glass laminate 100 (e.g., initiation point 242) to a second edge of the glass laminate (e.g., termination point 244). During the cutting, glass laminate 100 is severed such that glass laminate segment 260 is separated from a remaining portion 270 of the glass laminate. The cutting can be accomplished using a single-step process or a multi-step process as described herein in reference to FIGS. 7-9.

In some embodiments, a method comprises forming a relief channel in a glass laminate comprising a glass sheet laminated to a non-glass substrate, the relief channel comprising a first segment and a second segment intersecting the first segment at a relief intersection and disposed at an angle α to the first segment. The method comprises cutting the glass laminate along a cutting path intersecting the first segment of the relief channel at a cutting intersection and ending at the cutting intersection to form a glass laminate segment with a perimeter defined by the cutting path. In some embodiments, α is about 30° to about 150°, and a depth of the relief channel, measured from a glass surface of the glass laminate, is about 30% to about 70% of a thickness of the glass laminate. Additionally, or alternatively, each of the first segment of the relief channel and the second segment of the relief channel is substantially linear; an end of the first segment of the relief channel is disposed at the relief intersection; and an end of the second segment of the relief channel is disposed at the relief intersection.

It will be apparent to those skilled in the art that various modifications and variations can be made without departing from the spirit or scope of the claimed subject matter. Accordingly, the claimed subject matter is not to be restricted except in light of the attached claims and their equivalents.

1. A method comprising;
cutting a glass laminate comprising a glass sheet laminated to a non-glass substrate along a cutting path to form a glass laminate segment comprising a perimeter at least partially defined by the cutting path;
wherein prior to the cutting, a relief channel is formed in the glass laminate, the relief channel comprising a first segment aligned with a final segment of the cutting path and a second segment extending away from the final segment of the cutting path such that, after the cutting, the second segment is disposed outside of the glass laminate segment.

2. The method of claim 1, wherein a depth of the relief channel, measured from a glass surface of the glass laminate, is about 30% to about 70% of a thickness of the glass laminate.

3. The method of claim 1, wherein each of the first segment and the second segment of the relief channel is substantially linear.

4. The method of claim 3, wherein:
the second segment of the relief channel extends from the first segment of the relief channel; and
an angle α between the first segment of the relief channel and the second segment of the relief channel is about 30° to about 150°.

5. The method of claim 1, wherein the relief channel is substantially L-shaped.

6. The method of claim 1, wherein:
the second segment of the relief channel extends from the first segment of the relief channel; and
an end of the second segment of the relief channel is disposed at an end of the first segment of the relief channel.

7. The method of claim 1, wherein the cutting path comprises an initial segment intersecting the first segment of the relief channel.

8. The method of claim 1, further comprising applying a protective film to the surface of the glass laminate prior to the cutting step.

9. (canceled)

10. The method of claim 1, wherein the cutting path extends from a first edge of the glass laminate to a second edge of the glass laminate.

11. The method of claim 10, wherein the first segment of the relief channel extends to the second edge of the glass laminate.

12. The method of claim 1, wherein the cutting path comprises a closed loop defining the perimeter of the glass laminate segment.

13. (canceled)

14. The method of claim 1, wherein the forming step comprises forming the recess with a mechanical cutting tool.

15. The method of claim 1, wherein the cutting step comprises:
forming a cutting channel in the glass laminate, the cutting channel defining a first region of the glass laminate and a second region of the glass laminate coupled to each other by a web portion disposed between the cutting channel and a surface of the glass laminate, a thickness of the web portion at least about 10% of a thickness of the glass laminate;
expanding the cutting channel to reduce the thickness of the web portion and form a reduced web portion with a thickness of at least about 0.1% of the thickness of the glass laminate; and
severing the reduced web portion to form the glass laminate segment;
wherein the forming the cutting channel comprises a single pass with a first cutting tool, and the expanding the cutting channel comprises a single pass with a second cutting tool.

16. The method of claim 1, wherein the glass sheet is a flexible glass sheet with a thickness of at most about 300 μm.

17. (canceled)

18. A method comprising:
forming a cutting channel in a glass laminate comprising a glass sheet laminated to a non-glass substrate, the cutting channel defining a first region of the glass laminate and a second region of the glass laminate coupled to each other by a web portion disposed between the cutting channel and a surface of the glass laminate, a thickness of the web portion at least about 10% of a thickness of the glass laminate;
expanding the cutting channel to form an expanded cutting channel and reduce the thickness of the web portion to form a reduced web portion with a thickness of at least about 0.1% of the thickness of the glass laminate; and
severing the reduced web portion to form a glass laminate segment;
wherein the forming the cutting channel comprises a single pass with a first cutting tool, and the expanding the cutting channel comprises a single pass with a second cutting tool.

19. The method of claim 18, wherein each of the first cutting tool and the second cutting tool comprises a router bit, and the second cutting tool comprises a greater number of flutes than the first cutting tool.

20. The method of claim 18, wherein the expanding the cutting channel comprises reducing a dimension of the first region of the glass laminate to form a reduced first region.

21-22. (canceled)

23. The method of claim 18, wherein the cutting channel extends entirely through the glass sheet of the glass laminate.

24. The method of claim 18, wherein a ratio of a width of the expanded cutting channel to a width of the cutting channel is about 1.01 to about 2.

25. The method of claim 18, wherein a width of the expanded cutting channel is about 0.1 mm to about 10 mm larger than a width of the cutting channel.
